(19) United States
(12) Patent Application Publication
(10) Pub. No.: US 2018/0323535 A1
(43) Pub. Date: Nov. 8, 2018

(54) DUST CAP FOR AN ELECTRICAL CONNECTOR

(71) Applicant: HUGHES ELECTRONICS LIMITED, London (GB)

(72) Inventor: Glyn HUGHES, London (GB)

(21) Appl. No.: 15/775,749

(22) PCT Filed: Nov. 11, 2016
(86) PCT No.: PCT/GB2016/000201

§ 371 Date: May 11, 2018

(30) Foreign Application Priority Data
Nov. 13, 2015 (GB) 1520049.6

(51) Int. Cl. H01R 13/52

(52) U.S. Cl. CPC H01R 13/5213; H01R 2103/00; H01R 13/5216

(57) ABSTRACT

A dust cap for an electrical connector is disclosed. It comprises a sleeve portion closed off at one end by an end-wall, either or both of which are at least partially transparent. It further comprises a sheet-like humidity indicator located substantially adjacent the inner surface of either or both of the sleeve portion and the end-wall inner surface, which humidity indicator is arranged to change appearance from an initial state in the event that the humidity within the cap exceeds a particular value.

### FIELD OF THE INVENTION

This invention relates to a dust cap for an electrical connector.

### BACKGROUND OF THE INVENTION

Electrical connectors are widespread, one example being a so-called 7/16 coaxial connector and another being a 4.3/10 coaxial connector which are 50 ohm threaded RF connectors used to join coaxial cables. These are among the most widely used high-power RF connectors in cellular network antenna systems.

Problems are encountered due to contaminants and moisture entering the connector, for which reason a dust cap may be used to close-off a connector. Moisture presents a particular problem, possibly causing corrosion and/or reflections in the signal by altering the characteristic impedance. Moisture can become trapped as a result of exposure to swings in temperature and atmospheric pressure in the presence of relative humidity.

One solution proposed is to provide a chamber which sits over a connector, which chamber houses a quantity of desiccant beads which absorb some of the moisture. The beads are relatively bulky, however, and therefore the chamber is also. The presence of moisture is not immediately apparent, which may be useful to indicate vulnerabilities, e.g. poor moisture sealing.

### SUMMARY OF THE INVENTION

According to a first aspect of the invention, there is provided a dust cap for an electrical connector, comprising a threaded sleeve portion closed off at one end by an end-wall, either or both of which are at least partially transparent, further comprising a sheet-like humidity indicator located substantially adjacent the inner surface of either or both of the sleeve portion and the end-wall inner surface, which humidity indicator is arranged to change appearance from an initial state in the event that the humidity within the cap exceeds a particular value.

The end-wall may be transparent and the humidity indicator may be located adjacent the end wall.

The sleeve portion may be transparent and the humidity indicator may be located adjacent the sleeve, side-wall portion.

The humidity indicator may be shaped to the form of both the end-wall and side wall portion.

The humidity indicator may comprise a sheet of material wrapped around all or the majority of the sleeve portion inner surface.

The humidity indicator may be provided in the form of a piece of paper, card or fabric.

The humidity indicator may be adhered to the inner surface.

The humidity indicator may be received within a shaped recess formed within the end-wall inner surface.

The humidity indicator may comprise paper, card or fabric impregnated with cobalt (II) chloride, or copper (II) chloride.

The humidity indicator may be configured to change colour in the presence of humidity exceeding a particular value.

The humidity indicator may be configured to change from its initial state to one of a plurality of possible colours which refer to respective levels of humidity.

The dust cap may further comprise a washer which surrounds the humidity indicator.

The humidity indicator may be reversible.

The dust cap may further comprise a water detection label.

The cap according to any preceding definition may be dimensioned and arranged to be used with a 7/16 and/or a 4.3/10 coaxial connector, or indeed any coaxial connector, male or female.

A further aspect provides a dust cap for covering an electrical terminal, comprising a transparent sleeve closed off at one-end by a transparent wall, a planar humidity indicating sheet being mounted within either or both the sleeve and end wall so as to be visible from the exterior when mounted to an electrical terminal.

### BRIEF DESCRIPTION OF THE DRAWINGS

The invention will now be described by way of non-limiting example with reference to the accompanying drawings, in which:

FIG. 1 is a perspective view of a dust cap in accordance with the invention;

FIG. 2 is an exploded perspective view of the FIG. 1 dust cap;

FIG. 3 is a perspective view of the FIG. 1 dust cap, emphasising a fully transparent example;

FIG. 4 is a plan view of the FIG. 1 dust cap;

FIG. 5 is a perspective view of the FIG. 1 dust cap when connected to a 7/16 coaxial connector;

FIGS. 6a and 6b show plan and perspective views of a further embodiment dust cap in accordance with the invention;

FIG. 7 is a perspective view of the FIG. 6 dust cap when connected to a 7/16 coaxial connector;

FIGS. 8a, 8b and 8c show perspective, exploded perspective and exploded side views of the FIG. 6 dust cap when using a further, transverse, humidity indicator;

FIGS. 9a and 9b show perspective and exploded views of the FIG. 8 dust cap with further humidity indicator when connected to a 7/16 DIN coaxial connector;

FIGS. 10a, 10b and 10c show perspective, exploded perspective and exploded side views of a further embodiment dust cap in accordance with the invention;

FIGS. 11a, 11b and 11c show perspective front, side and rear views of the FIG. 10 dust cap when used with a larger disk-type humidity indicator; and

FIG. 12 is a perspective view of the FIG. 11 dust cap when connected to a 7/16 coaxial RF connector.

### DETAILED DESCRIPTION OF PREFERRED EMBODIMENTS

Embodiments herein describe a dust cap 1 dimensioned and arranged to close-off one end of a 7/16 (in this example female) coaxial connector, but the principle of operation may be applied to any electrical connector where it is desirable to avoid problems caused by moisture and/or changes in relative humidity. Another example is a 4.3/10 coaxial connector.

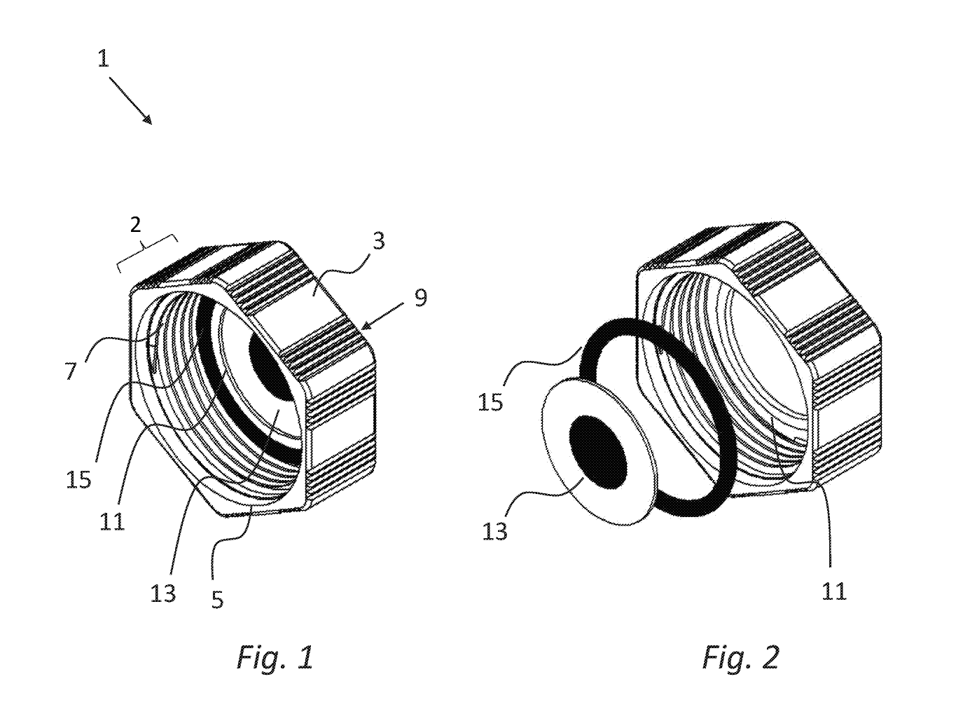

Referring to FIGS. 1 and 2, the dust cap 1 comprises a sleeve portion 2 having a hexagonal outer wall 3 with an inner sleeve 5 which carries threading 7 which cooperatively screws over threading of the RF connector. The inner sleeve 5 is closed-off at the distal end by a wall 9 which is transparent. The wall 9 is shaped and dimensioned with a circular sunken recess 11 within which is mounted a disk 13 of humidity indicating paper, card or fabric which can therefore be viewed from the reverse side. A rubber washer or O-ring 15 is mounted within the sleeve 5 and helps provide a watertight fit when connected over a connector.

The disk 13 of humidity indicating paper, card or fabric may be of any commercially available type, and is of the sort that changes colour when the indicated relative humidity (RH) is exceeded. The disk 13 may comprise blotting paper impregnated with a cobalt (II) chloride base or copper (II) chloride base. Typically, it will change from blue (less than indicated RH) to a pink or red colour (greater than indicated RH) to provide a visual indication through the transparent wall 9 that moisture is present, indicative perhaps of the washer 15 failing, or other action being required. The disk 13 may be arranged to cycle through different colour graduations corresponding to respective moisture thresholds. Preferably, although not necessarily, the disk 13 is of the sort that is reversible, i.e. the colour will revert to its original form when levels subside, or when the disk is dried-out manually, so that replacement is not needed and the disk can be re-used. The central spot indicated in the Figures is that part which will change colour.

By virtue of the disk 13 being substantially planar and very thin, the cap 1 is less bulky and is inexpensive. The disk 13 can, if needed, be easily replaced and the cap reused. The disk 13 can be provided in self-adhesive form, or can simply be retained within the recess 11.

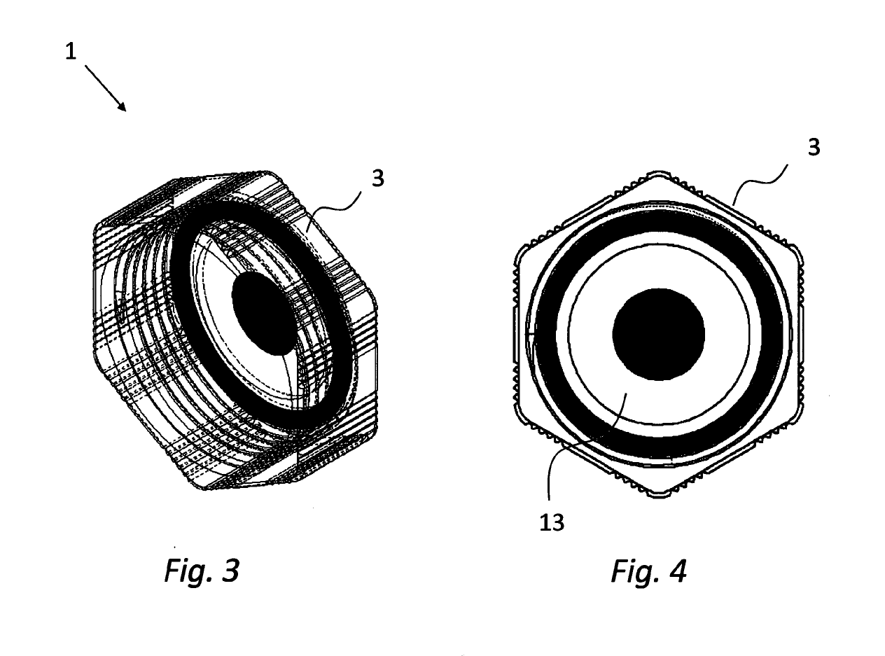

As shown in FIGS. 3 and 4, the entirety of the cap 1 can be made of transparent material, i.e. both end wall and sleeve wall 3, making it possible to view both sides of the disk 13, even when the cap is located over a connector (which assumes that there is some gap between the connector end and the disk.) This may be advantageous when the connector and cap is located in a hard-to-access location, with it being more convenient to view the side, or reverse, of the cap 1 than its top or front end.

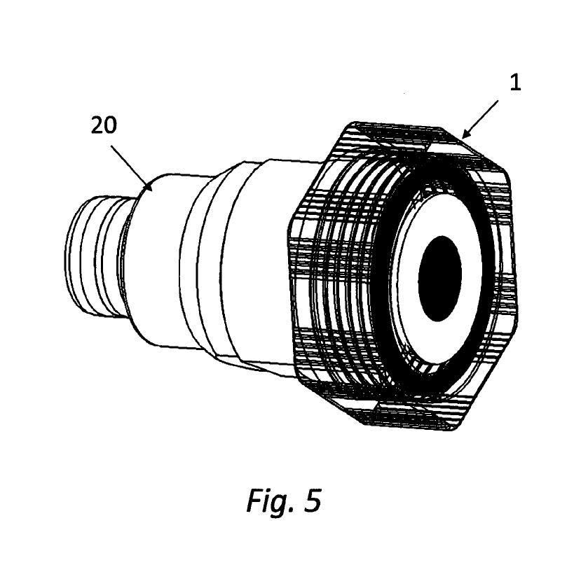

FIG. 5 shows the above cap 1 mounted to a 7/16 coaxial connector 20.

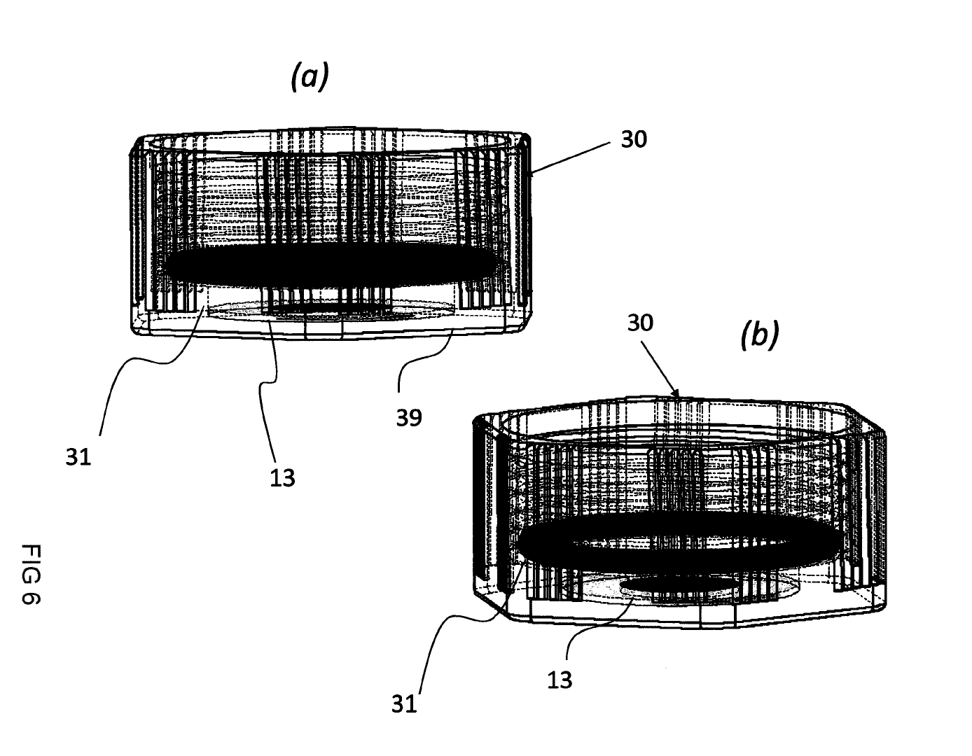

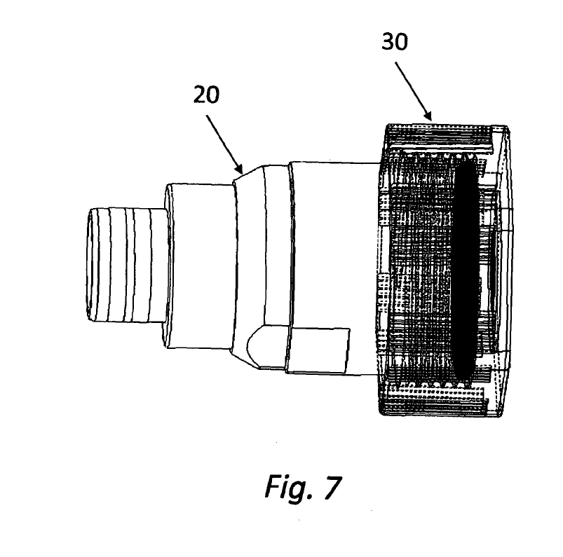

Referring to FIGS. 6a, 6b and 7, a further embodiment cap 30 is shown, which is similar to that described previously but has a deeper recess 31 defined by a wall sunken into end-wall 39 within which the disk 13 locates. This makes it easier to view the humidity indicating dot of disk 13 from multiple angles, particularly the reverse angle.

FIG. 7 shows the cap 30 mounted to the 7/16 coaxial connector 20. This shows how the disk 13 can be viewed from the reverse angle.

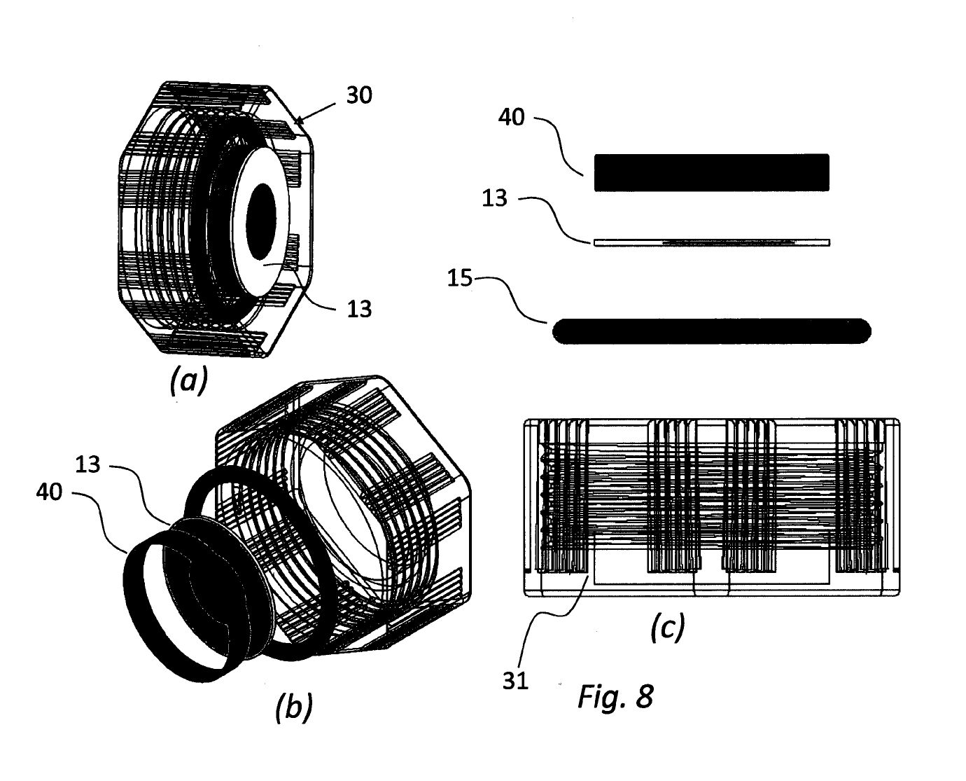

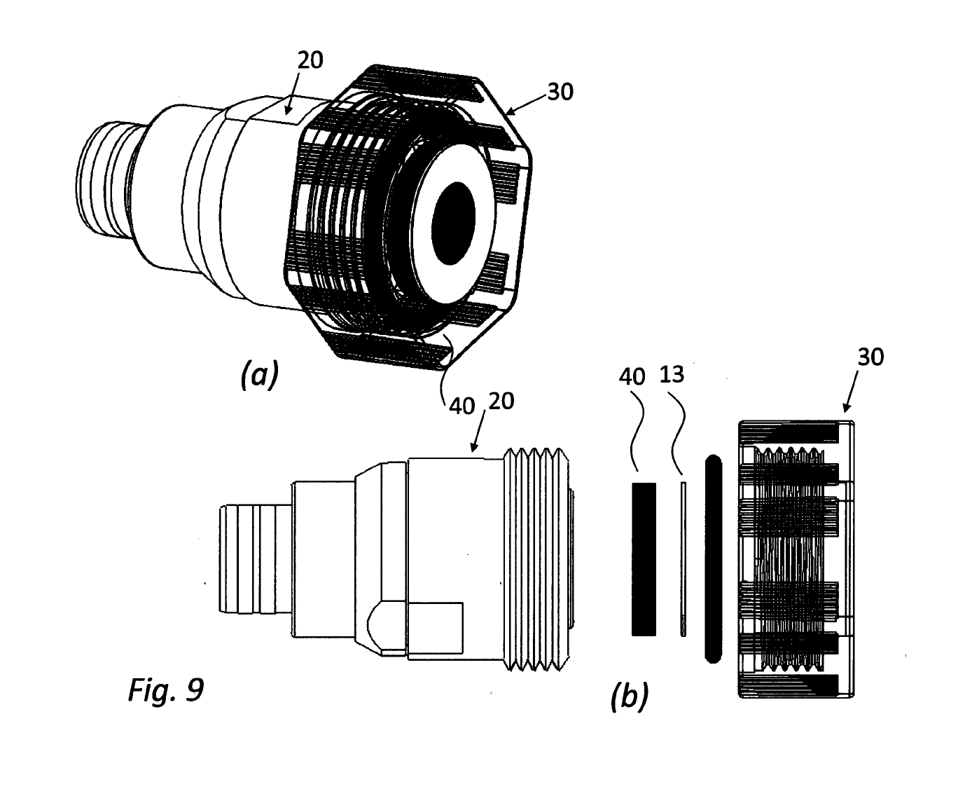

Referring to FIGS. 8a, 8b, 8c, and 9a and 9b, the cap 30 is shown, utilising in addition to the humidity indicating disk 13, a narrow strip 40 in (in this case) loop or ring form formed of the same planar and impregnated material. This strip 40 is configured to locate within the recess 31, against its inner wall, in a plane transverse to that of disk 13. This provides an improved, three-dimensional view of the humidity situation, viewable from almost all angles in use.

In some embodiments, the disk 13 and strip 40 can be combined in a single connected, or integral form, being effectively cup-shaped.

FIGS. 9a and 9b show the cap 30 with this form of indicator 13, 40 when located over the 7/16 coaxial connector 20. The indicator 13, 40 is viewable from all angles.

In some embodiments, only the strip 40 may be used, i.e. without the disk 13. The strip 40 need not be joined into a complete loop as shown. It may simply locate around part of the recess 31.

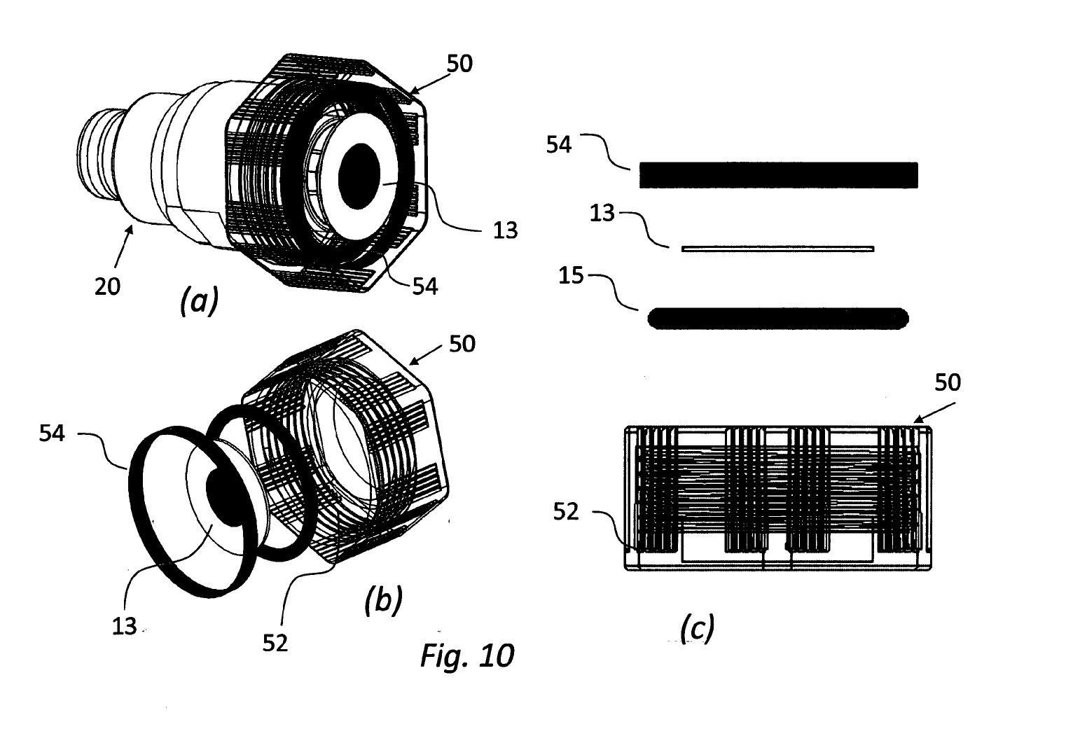

Referring to FIG. 10, a further embodiment cap 50 is shown, which is similar to those described previously but has a wider recess 52 within which a narrow strip 54 locates transverse to the disk 13. The fact that the strip 54 is closer to the outer wall of the cap 50 makes it easier to view from different angles, particularly reverse angles.

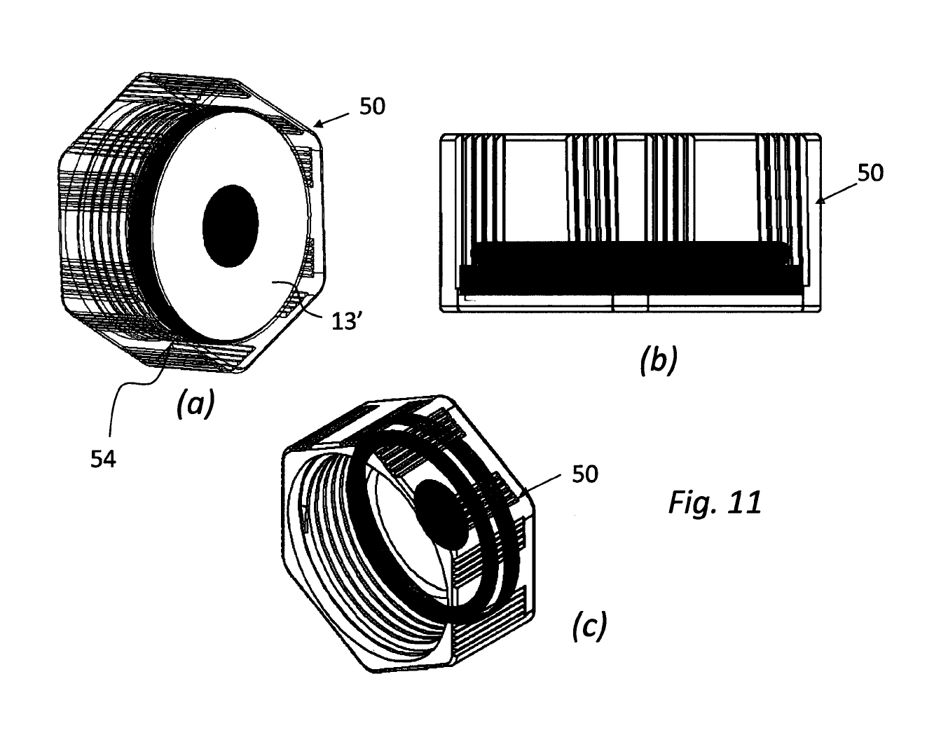

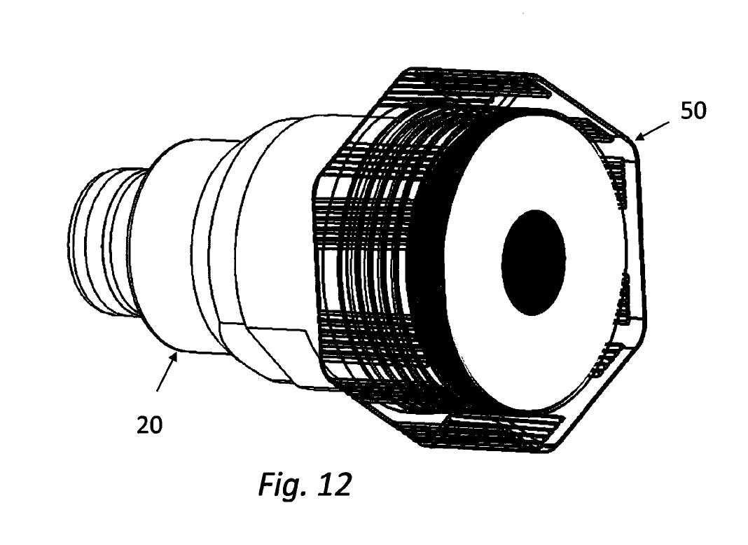

As shown in FIGS. 11 and 12, a disk 13′ of greater diameter may be located within the recess 52. Again, the disk 13 and strip 54 may be provided as separate or connected elements.

In some embodiments, two concentric recesses may be formed in the cap 50, one for the disk 13 and one, wider recess, for the strip 54.

In some embodiments, only the sleeve wall 3 may be transparent. In some embodiments, only part of the sleeve wall 3 and/or end wall 9, 39 may be transparent, sufficient to view the indicators.

In some embodiments, the arrangement and dimensions of the above caps, e.g. the extent of the threads for connection to the connector, and the recess, ensures that the indicators are sufficiently spaced from the connector to allow the former to be viewed.

In addition, the cap 1 can employ a water detection label, with adhesive side detection) which changes from white to red after contact with moisture.

The cap 1 has been tested to IP68 ratings.

In summary, the above-mentioned embodiments describe a dust cap that provides the required humidity indication without the need for a desiccant or silica based material, which is a bulky material that needs to absorb moisture in order to provide a visual indication. Such desiccant-based devices have the drawback that they may indicate a moisture condition even if (or after) the connector is dried. The present embodiments, in contrast, may indicate the current moisture or humidity condition in real-time or near real-time, reverting back to their previous state or colour when humidity subsides. It is also possible to re-cycle the indicating card by drying for subsequent use. This, in addition to the low-profile dimensions of the indicating card make it a cheaper product and the cap itself can be made smaller without the need to hold desiccant material in bead form, or in a sealed capsule.

Although the above has been described in relation to a female coaxial connector, embodiments are applicable to male coaxial connectors also. Whilst a dust cap for a female connector screws over the outside, as shown in the Figures, a dust cap for a male connector is different in that it is configured and arranged to screw over the inside of the connector's threads.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A dust cap for an electrical connector, comprising:
a sleeve having a sleeve wall and being closed off at one end by an end wall, wherein either of the sleeve wall and the end wall are at least partially transparent;
a humidity indicator located proximate an inner surface of either of the sleeve wall and the end wall, which humidity indicator changes appearance from an initial state wherein the humidity indicator exhibits a first characteristic to a humid state in which the humidity indicator exhibits a second, different characteristic when humidity within the cap exceeds a particular value, the humidity indicator returning from the humid state to the initial state when the humidity within the cap subsides below the particular value.

2. The dust cap according to claim 1, wherein the end wall is transparent and the humidity indicator is located adjacent the end wall.

3. The dust cap according to claim 1, wherein the sleeve portion is transparent and the humidity indicator is located adjacent the sleeve wall of the sleeve.

4. The dust cap according to claim 1, wherein both the sleeve wall and end wall are transparent, and the humidity indicator comprises a first portion located adjacent the end wall, and a second portion located around at least part of the sleeve wall.

5. The dust cap according to claim 3, wherein the humidity indicator comprises a sheet of material wrapped around all of the sleeve wall inner surface.

6. The dust cap according to claim 1, wherein the humidity indicator comprises a piece of paper, card or fabric.

7. The dust cap according to claim 6, wherein the humidity indicator is adhered to the inner surface of either of the sleeve wall or the end wall.

8. The dust cap according to claim 6 or, wherein the humidity indicator is received within a shaped recess formed in the end wall inner surface.

9. The dust cap according to claim 6, wherein the humidity indicator comprises paper, card or fabric impregnated with cobalt (II) chloride, or copper (II) chloride.

10. The dust cap according to claim 1, wherein the first characteristic is a first color and the second characteristic is a second, different color, wherein the humidity indicator changes from the first color to the second color in the presence of humidity exceeding the particular value.

11. The dust cap according to claim 10, wherein the humidity indicator changes from the initial state to the humid state and to additional states beyond the humid state based on an amount of humidity in the cap, wherein each state corresponds to one of a plurality of colors, and wherein each color corresponds to a different amount of humidity.

12. The dust cap according to claim 1, further comprising a washer which surrounds the humidity indicator.

13. The dust cap according to claim 1, further comprising a water detection label coupled to the dust cap.

14. The dust cap according to claim 1, wherein the dust cap has a size and a shape to be used with a coaxial connector having an inner contact measuring 7 millimeters and an outer contact measuring 16 millimeters.

15. The dust cap according to claim 1, wherein the dust cap has a size and a shape to be used with a coaxial connector having an inner contact measuring 4.3 millimeters and an outer contact measuring 10 millimeters.

16. A dust cap for covering an electrical terminal, comprising:
a transparent sleeve closed off at one end by a transparent wall, a planar humidity indicating sheet being mounted against either of the sleeve and end wall so as to be visible from the exterior of the dust cap.

17. A dust cap for covering an electrical terminal, comprising:
a sleeve closed off at one end by a wall, the sleeve carrying threads on its inner surface for cooperative engagement with threads of a terminal;
a gap defined between a distal end of the threads and the end wall, in which gap a space for mounting a humidity indicator is provided proximate a transparent part of the cap.

18. The dust cap of claim 17 wherein the transparent part of the cap is the wall of the sleeve.

19. The dust cap of claim 17 wherein the transparent part of the cap is the sleeve.

20. The dust cap of claim 17 wherein the space for mounting the humidity indicator includes a recess in the wall of the sleeve.
